(19) United States
(12) Patent Application Publication
(10) Pub. No.: US 2025/0153553 A1
(43) Pub. Date: May 15, 2025

(54) TEMPERATURE CONTROL DEVICE FOR CONTROLLING THE TEMPERATURE OF AN ELECTRIC DRIVE AXLE OF A MOTOR VEHICLE

(71) Applicant: ZF Friedrichshafen AG, Friedrichshafen (DE)

(72) Inventors: Tobias Höche, Hallstact (DE); Axel Rohm, Schonungen (DE); Alexander Markow, Schweinfurt (DE); Cora Carlson, Dittelbrunn (DE)

(73) Assignee: ZF Friedrichshafen AG, Friedrichshafen (DE)

(21) Appl. No.: 18/833,554

(22) PCT Filed: Jan. 24, 2023
(86) PCT No.: PCT/EP2023/051659

§ 371 Date: Jul. 26, 2024

(30) Foreign Application Priority Data
Jan. 26, 2022 (DE) 10 2022 200 837.5

(51) Int. Cl. B60K 1/00; B60K 11/02

(52) U.S. Cl. CPC B60K 1/00; B60K 11/02; B60K 2001/006

(57) ABSTRACT

A temperature control device for controlling the temperature of an electric drive axle for a motor vehicle, comprising an inlet and return, and at least one valve with which a temperature control path can be altered between the inlet and return, wherein the valve can alter the sequence in which the temperature control medium flows through at least two components, in particular a control unit and an electric machine, in the temperature control path.

The invention relates to a temperature control device for controlling the temperature of an electric drive axle in a motor vehicle that has an inlet and a return, and at least one valve for altering the temperature control path between these two.

There are temperature control devices for controlling the temperature of electric drive axles in motor vehicles in the prior art. These types of temperature control devices normally define a temperature control path between an inlet and return through which the temperature control medium, in particular a coolant, can be conducted, in which the temperature control path for the temperature control medium passes through or along various components of the electric drive axle in the motor vehicle in order to absorb heat therefrom. The temperature control medium can be conducted through the return of a temperature control component, e.g. a cooling component such as a heat exchanger, and be subsequently returned to the inlet. In other words, the temperature control path normally forms a circuit.

The temperature control medium can flow through various components of the electric drive axle in a defined sequence, in particular, first through a control unit, e.g. power electronics, and then an electric machine, specifically an electric motor. When the temperature control medium passes through the various components, it changes the temperatures thereof. If the temperature control medium is intended for cooling purposes, it becomes warmer as it passes through the individual components by a specific amount, e.g. 5° C.

Consequently, the temperature of the first component through which the temperature control medium flows may be more effectively controlled than that of downstream components because the temperature of the temperature control medium has already been altered by its flowing through the first component. There is a valve in the prior art that can alter the fundamental scope of the temperature control path between the inlet and the return. In particular, the valve can determine which component the temperature control medium flows through. In particular, the temperature of a control unit can be controlled, but not that of an electric machine, in particular at the start-up, to allow the electric machine to reach its operating temperature more slowly.

Once long-term operation has been reached, the temperature control medium flows through both the control unit and the electric machine, and any other components in the temperature control path, in the order in which they are located in the temperature control path, which thus determines the efficiency of the temperature control. It is not possible to change the temperature control in this case, because the sequence of the components in the temperature control path cannot be altered, such that upstream components are always cooled prior to downstream components. Because the individual components have different temperature control requirements in different operating situations, it is difficult to sufficiently cool all of these components.

The fundamental object of the invention is to create a better temperature control device for controlling the temperature of an electric drive axle in a motor vehicle.

This problem is solved by a temperature control device that has the features of claim 1. Advantageous embodiments are the subject matter of the dependent claims.

The invention therefore relates to a temperature control device for controlling the temperature of an electric drive axle in a motor vehicle, which has an inlet and a return, as well as a valve with which the temperature control path can be altered between the inlet and the return. The invention is based on the fact that the valve is designed to alter the sequence in which the temperature control medium flows through at least two components in the temperature control path, in particular a control unit and an electric machine. The temperature control path can therefore have at least a first and second segment, which can be selectively dedicated to the electric machine and control unit. The valve is designed to initially conduct the temperature control medium from the inlet to the first or second segment.

In other words, the temperature control medium can flow through the at least two components in any order to control their temperatures. By way of example, by allowing the temperature control medium to flow through a first component, to which the first segment is dedicated, prior to flowing through a second component, to which the second segment is dedicated, the efficiency with which the temperature of the first component is controlled is greater than that with which the temperature of the second is controlled. If the temperature control for the second component requires a higher efficiency, or performance, than that for the first component, the sequence in which the temperature control medium flows through them can be altered by the valve. In this case, the temperature control medium flows through the second segment, and therefore the second component, prior to flowing through the first segment, such that it has a more appropriate temperature when flowing through the second segment.

In a concrete example, the first segment can be dedicated to the electric machine, and the second can be dedicated to a control unit, in particular power electronics. If the current operating state requires more cooling in the electric machine than in the control unit, the valve can be set to first send the temperature control medium, or coolant, to the first segment, and thus cool the electric machine first. The temperature control medium coming from the inlet is therefore cooler when it flows through the first segment, such that it can better absorb heat from the electric machine. It then flows through the second segment and controls the temperature of the control unit.

If the control unit requires more temperature control in another operating situation, the valve can reverse the flow-through sequence, such that the temperature control medium flows through the second segment first, and the control unit is therefore cooled before it flows through the first segment to cool the electric machine. In this situation, cooler temperature control medium flows first through the second segment in order to cool the control unit more effectively.

Aside from successively flowing through the two components, the temperature control medium can also flow through them in parallel when the valve alters the temperature control path such that the temperature control medium flows through the first and second components, or first and second segments, at the same time, as shall be explained in greater detail below. Although for purposes of simplicity, only two components are referred to in the temperature control path in this application, there can fundamentally be any number of components, the sequence of which, through which the temperature control medium flows, can be altered by one or more valves. This fundamentally allows the efficiency of the temperature control to be concentrated on that component in the temperature control path where the temperature control is most important at any given time.

The term “temperature control” can be understood to mean, or used to refer to both cooling and heating. Depending on the temperature of the temperature control medium in relation to that of the component, it can either be cooled or heated. When in use, the electric drive axle in a motor vehicle is normally cooled, i.e. the temperature control device can be used in this case to cool the electric drive axle. The temperature control medium in this case can be a coolant, and the temperature control path and temperature control component can be understood to be a coolant path and cooling component.

According to one embodiment of the temperature control device, the valve can be designed to alter the flow-through sequence for the temperature control medium based on performance requirements. The flow-through sequence can be selected, or determined, in this embodiment such that immediate requirements for individual components can be taken into account. In other words, the component that currently requires more cooling can be cooled to a greater extent. The requirements for individual components can be obtained from a central control unit in the motor vehicle. This central control unit can be different than the control unit or power electronics referred to above, or the above control unit can determine these requirements.

The valve can be controlled with switching signals corresponding to the performance requirements in order to establish or alter the flow-through sequence. In the simplest case, the valve can be controlled or regulated such that the inlet and return can be selectively connected to the first and second segments, such that the temperature control medium can flow from the inlet into the first segment and subsequently into the second segment, and from there to the return, or from the inlet into the second segment, and then into the first segment, after which it flows to the return.

As explained above, the performance requirements can be taken into account in establishing the flow-through sequence. The performance requirements can involve peak performance requirements, for which the valve is designed such that the temperature control medium flows through a section of the control unit in the temperature control path prior to flowing through a section of a machine. The first and second segments can be dedicated to either the control unit or the electric machine.

The “control unit segment” is the segment of the temperature control path dedicated to the control unit, which can either be the first or second segment. A peak performance is understood to be a performance for a comparatively short interval resulting in a comparatively intense heating of the control unit, in particular the power electronics. The components of the power electronics have a lower thermal time constant than those of the electric machine and therefore heat up much more quickly. Overheating of delicate electric and electronic components, in particular semiconductors, should be avoided.

Because the electric machine is a thermal conductor in these peak performances, it is advantageous to cool the control unit to a greater extent. The valve changes the flow-through sequence for peak performances such that the temperature control medium flows through the control unit segment prior to flowing through the machine segment, thus cooling the control unit while the temperature control medium is colder. The peak performance requirements can be defined for the current performance and/or temperature gradients, and/or temperature of the control unit. The peak performance requirements can also be detected on the basis of electrical current. If this current exceeds a specific threshold value, a peak performance requirement can be set for controlling the valve.

In another embodiment, the performance requirement can be a long-term performance requirement for which the valve is designed to conduct the temperature control medium to the control unit segment in the temperature control path after flowing through the machine segment. In comparison with the peak performance, the long-term performance is characterized by a performance over a longer period of time. A long-term performance can be understood to be long-term operation of the electric drive axle, e.g. a driving mode at a relatively constant speed. The long-term performance can also be defined through the electric current, in which the peak performance is characterized by a current lying above a threshold value. In comparison, the long-term performance is characterized by an electric current lying below this threshold value. The lengths of the performances can be used to define the performance requirements, in that the peak performances last less than 1 minute, and the long-term performances last longer than 1 minute. The temperature gradients and/or the temperatures of the components can be used to determine the performance requirements.

Because the electric machine normally generates more heat during the long-term performance, which then must be discharged through the temperature control path, it makes sense to for the valve to first direct the temperature control medium through the machine segment and subsequently the control unit segment. Consequently, a comparatively colder temperature control medium flows through the electric machine first and efficiently cools it, because the electric machine requires more cooling during the long-term performance than the control unit.

The temperature control device can also be designed such that the performance requirements form a thermal capacity for at least one of the components in the temperature control path, in which the valve is designed to determine the flow-through sequence on the basis of a current or future thermal capacity of the respective component. The term, “thermal capacity,” characterizes the capacity of the respective component to be further heated, or to generate more heat during operation thereof such that at least one of the components therein becomes hotter. In other words, the thermal capacity indicates whether the respective component has reached its thermal threshold, or how close it is thereto. This enables a determination of whether a first component can get any hotter without having a negative impact on its operation, and also whether a second component can get any hotter without having a negative impact on its operation.

It can then be decided which component needs cooling the most, e.g. that component that is operating closest to its thermal capacity. The current temperatures or temperature gradients of the individual components can be observed to determine the thermal capacity. It can be decided, in particular by the control unit, which of the components require cooling to a greater extent on the basis of the temperatures that the individual components can be at within their operating limits, and how these change. The control unit can use at least one thermal model for this, with which it then models the temperatures or course of the temperatures. This increases the overall operating capacity of the electric drive axle, because the component closest to its thermal capacity can be better cooled to therefore prevent, or at least slow, any reductions in the performance thereof.

According to another embodiment of the temperature control device there can be at least one bypass in the path between two components, in particular a control unit and an electric machine, which connects to the return. By connecting the segment of the temperature control path between the at least two components to the return, it is possible to control the temperatures of the two components at the same time, because the inlet is connected by the valve to both the first and second components, or first and second segments, and the intermediate segment is connected to the return by the bypass. It is also possible to control the temperatures of the first and second segments separately by connecting the inlet to the first and second segments with the valve, and conducting the temperature control medium to the return with the bypass without ever having to flow through either of the other segments.

There can be a bypass valve in another embodiment of the temperature control device, which determines how much of the medium flows through the bypass. The bypass valve can be adjusted to determine both the direction and flow volume of the medium flowing through the bypass. It is therefore possible, as explained above, to control the temperatures of the at least two components at the same time, as well as to determine the direction in which the medium flows and control the temperatures of the individual components individually.

The temperature control device can also be designed to reduce an overall pressure drop. As explained above, the amount of medium flowing through the bypass can be controlled by the bypass valve. This has an effect on the overall pressure drop in the temperature control path. By way of example, instead of flowing through the individual segments, the temperature control medium can be conducted through the bypass, which has a much lower flow resistance than the segments of the temperature control path in which the individual components are located. Moreover, it is possible to increase the pressure drops in the first and second segments by reducing the pressure drop in the temperature control path without increasing the overall pressure drop. This improves the temperature control of the individual components due to the increase in the individual pressure drops.

In addition to the temperature control device, the invention also relates to a motor vehicle that contains the temperature control device described above. The invention also relates to a method for controlling the temperature of an electric drive axle in a motor vehicle, which has an inlet and a return, and at least one valve with which the a temperature control path can be altered between the inlet and return sections, in that the sequence in which the temperature control medium flows through the at least two components, in particular a control unit and an electric machine, is altered in the temperature control path by the valve.

All of the advantages, details, and features described in reference to the temperature control device apply in their entirety to the motor vehicle and the method.

The invention shall be explained in greater detail below in reference to the drawings of exemplary embodiments. The drawings are schematic illustrations in which:

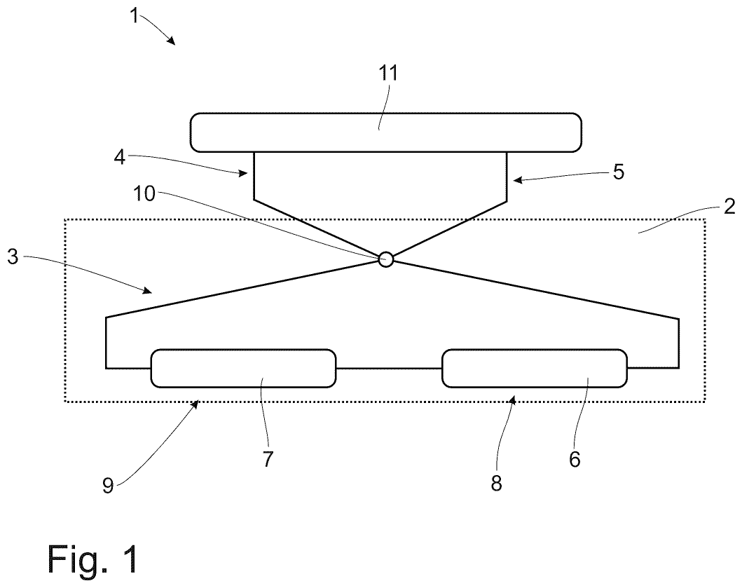

FIG. 1 shows a section of an electric drive axle for a motor vehicle that has a temperature control device according to a first exemplary embodiment; and

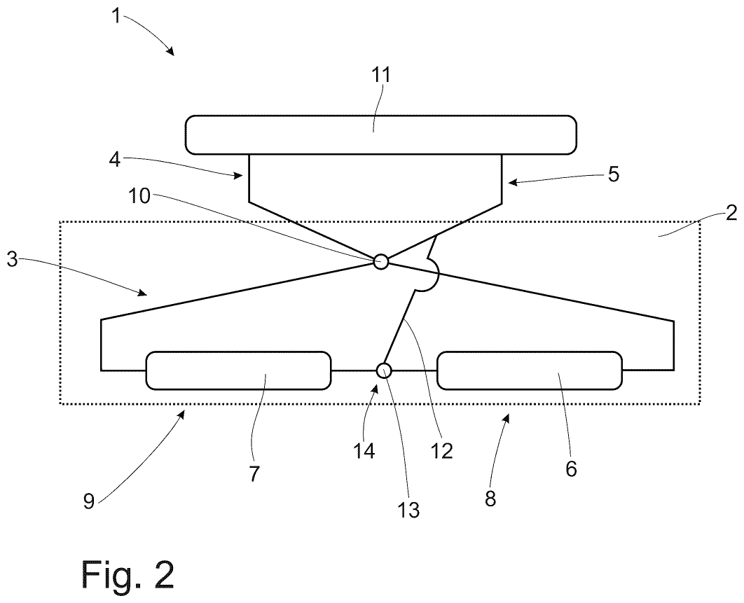

FIG. 2 shows a section of an electric drive axle for a motor vehicle that has a temperature control device according to a second exemplary embodiment.

FIG. 1 shows a schematic section of an electric drive axle 1 for a motor vehicle, which has a temperature control device 2 that defines a temperature control path 3 with an inlet 4 and a return 5. Any of the components or parts of the electric drive axle 1 can be integrated in the temperature control path 3. The drawings only show a control unit 6, e.g. power electronics, and an electric machine 7, e.g. an electric motor, which are in a first segment 8 and second segment 9 of the temperature control path 3. The terms, “first segment 8” and “second segment 9” are only selected as examples, and are therefore interchangeable, or can be assigned arbitrarily.

There can also be any number of other components, in addition to the control unit 6 and the electric machine 7 integrated in a corresponding number of additional segments in the temperature control path 3. The segments 8, 9 are thermally coupled to the respective components such that it is possible to cool or heat them. The temperature control path can, but does not have to, pass directly through the components, or it can come in thermal contact therewith, in order to cool or heat them.

The temperature control device 2 also has a valve 10 that is fundamentally designed to alter the temperature control path 3 between the inlet 4 and the return 5. In particular, the valve 10 can alter the sequence in which the temperature control medium flows through the segments 8, 9 in the temperature control path 3. By this means, the sequence in which the medium flows through the control unit 6 and electric machine 7 can be adapted to the current operating situation.

The valve 10 can determine the sequence in which the temperature control medium flows through the components such that it first flows from the inlet 4 to the first segment 8 to which the control unit 6 is connected, thus arriving in the second segment 9 after flowing through the first segment 8, where it then controls the temperature of the electric machine 7. The temperature control medium can subsequently flow into a temperature control component 11, e.g. a cooling device, and then be returned to the inlet 4. The temperature control path 3 thus forms a circuit.

The valve 10 can also determine the sequence in which the temperature control medium flows such that it first flows from the inlet 4 into the second segment 9, to which the electric machine 7 is connected. After flowing through the second segment 9, the temperature control medium is conducted into the first segment 8. In other words, first the temperature of the electric machine 7 is controlled in this state, and then the control unit 6. The temperature control medium is at different temperatures when it reaches each of the components, depending the sequence in which it flows through them. If the components are to be cooled, for example, the cooling effect is greater in the upstream component in the sequence, because the temperature control medium is still colder at this point. When controlling the temperature of the first component in the temperature control path 3, heat from the first component is absorbed by the temperature control medium, thus increasing the temperature thereof. The temperature of the first component is therefore more efficiently controlled than that of the second component in the sequence.

The valve 10 can be coupled to a control unit, e.g. the control unit 6, or a second control unit, which is not shown. Control signals can therefore be sent to the valve 10, which then connects the inlet 4 and return 5 to either the first segment 8 or second segment 9. The flow-through sequence can be determined or altered on the basis of a performance requirement.

If there is currently a peak performance in which heat is generated to a greater extent in the control unit 6, the valve can determine the sequence in which the temperature control medium flows through the components, such that the control unit 6 is cooled more, i.e. the temperature control medium flows through the first segment 8 prior to flowing through the second segment 9. With long-term performance, the valve 10 can alter the flow-through sequence such that temperature of the electric machine 7 is controlled first, i.e. the temperature control medium flows through the second segment 9 before the first segment 8, such that the electric machine 7 is provided with a colder temperature control medium that the control unit 6.

It is also possible to use the thermal capacities of the individual components, in particular the control unit 6 and the electric machine 7, to control the valve 10. Thermal models, or the thermal capacity thresholds of the individual components can be used for this. If the current thermal capacities of the components indicate that one of them is being operated just below its thermal capacity threshold, the temperature control can be targeted to this component.

If the current temperature of the control unit 6 is at its maximum, thus requiring a reduction in the performance, the flow-through sequence can be altered such that the temperature control medium flows through the first segment 8, and thus the control unit 6, before flowing through the second segment 9 and therefore the electric machine 7. This lowers the current temperature of the control unit 6, such that it can be operated at a temperature that is lower than its thermal capacity threshold, or a temperature gradient can be lowered. This allows the drive axle 1 to continue to be operated, without reducing the performance thereof. The above description can also be applied to the reverse situation, in which the thermal capacity of the electric machine 7 has been reached before reaching the thermal capacity of the control unit 6.

FIG. 2 shows a second embodiment of an electric drive axle 1 for a motor vehicle. The preceding description, in particular with regard to the functioning of the temperature control device 2, can be applied in its entirety to the embodiment in FIG. 2. The same reference symbols are therefore used for the same components. This second embodiment of the electric drive axle, in particular the temperature control device 2 therein, has a bypass 12 with a bypass valve 13. The bypass 12 connects an intermediate segment 14 between the first segment 8 and second segment 9 to the return 5.

The bypass 12 allows for temperature control of both segments 8, 9 in parallel, in that the valve 10 connects the inlet 4 to both the first segment 8 and second segment 9, connecting the return to the intermediate segment 14. The valve 10 can be set such that either identical or different amounts of temperature control medium flow through first segment 8 and second segment 9. The bypass valve 13 can also be set such that the overall pressure drop in the temperature control path 3 can be reduced, in particular when the two segments 8, 9 are operated in series. Consequently, higher individual pressure drops can be obtained in the segments 8, 9, e.g. through an increased use of flow conductors, heat conductors, etc., without increasing the overall pressure drop in the entire temperature control path 3.

The bypass 12, or bypass valve 13, also allows for separate temperature control of the segments 8, 9. By way of example, the valve 10 can connect the inlet 4 to the first segment 8, and the bypass valve 13 can connect the intermediate segment 14 to the return 5 downstream of the first segment 8. In this case, no temperature control medium flows through the second segment 9. It is likewise possible to connect the inlet 4 to the second segment 9 with the valve 10, and connect the intermediate segment 14 to the return 5 downstream of the second segment 9. In this case, no medium flows through the first segment 8. It is also possible to regulate the amount of temperature control medium flowing through the individual segments 8, 9 such that an appropriate temperature control can be obtained in any operating situation. Instead of the bypass valve 13, a simple bypass branch with a fixed flow volume distribution can be used that is then connected to the bypass 12.

The above description can be applied in its entirety to a motor vehicle that contains the drive axle 1 and the temperature control device 2. The method described above for controlling the temperature of the electric drive axle 1 can be executed by the temperature control device 2. All of the advantages, details, and features described in reference to the temperature control device 2 can therefore be applied to such a vehicle and method for temperature control. The advantages, details, and features described in reference to individual exemplary embodiments are interchangeable, can be combined with one another, and can be applied to one another.

### REFERENCE SYMBOLS

1 drive axle
2 temperature control device
3 temperature control path
4 inlet
5 return
6 control unit
7 electric machine
8, 9 segments
10 valve
11 temperature control component
12 bypass
13 bypass valve
14 intermediate segment

1. A temperature control device for controlling a temperature of an electric drive axle for a motor vehicle, comprising:
an inlet and a return; and
at least one valve configured to alter a temperature control path between the inlet and the return,
wherein the valve is configured to alter a sequence in which a temperature control medium flows through at least two components, comprising a control unit and an electric machine, in the temperature control path.

2. The temperature control device according to claim 1, wherein the valve is configured to alter the sequence in which the temperature control medium flows through at least two components based on a performance requirement.

3. The temperature control device according to claim 2, wherein the performance requirement is a peak performance requirement, wherein the valve is configured to allow the temperature control medium to flow through a control unit segment in the temperature control path before flowing through a machine segment.

4. The temperature control device according to claim 2, wherein the performance requirement is a long-term performance requirement, wherein the valve is configured to allow the temperature control medium to flow through a control unit segment in the temperature control path after flowing through a machine segment.

5. The temperature control device according to claim 2, wherein the performance requirement is a thermal capacity of at least one of the components in the temperature control path, wherein the valve is configured to set the sequence in which the temperature control medium flows through at least two components on a basis of a current or future thermal capacity of a respective component.

6. The temperature control device according to claim 1, comprising:
at least one bypass between the control unit and the electric machine, with which a connection to the return can be obtained.

7. The temperature control device according to claim 6, comprising:
a bypass valve through which a flow volume through the bypass can be set.

8. The temperature control device according to claim 6, wherein the valve is configured to alter the temperature control path such that the temperature control medium flows through the at least two components in parallel.

9. The temperature control device according to claim 6, wherein the temperature control device is configured to reduce an overall pressure drop.

10. A motor vehicle comprising:
the temperature control device according to claim 1.

11. A method for controlling a temperature of an electric drive axle for a motor vehicle, which comprises an inlet and a return, and at least one valve configured to alter a temperature control path between the inlet and the return, wherein the method comprises:
altering, by the valve, a flow-through sequence for at least two components comprising a control unit and an electric machine in the temperature control path.

12. The method according to claim 11, comprising:
altering, by the valve, the flow-through sequence based on a performance requirement.

13. The method according to claim 12, wherein the performance requirement is a peak performance requirement,
the method comprising:
allowing, by the valve, the temperature control medium to flow through a control unit segment in the temperature control path before flowing through a machine segment.

14. The method according to claim 12, wherein the performance requirement is a long-term performance requirement,
the method comprising:
allowing, by the valve, the temperature control medium to flow through a control unit segment in the temperature control path after flowing through a machine segment.

15. The method according to claim 12, wherein the performance requirement is a thermal capacity of at least one of the components in the temperature control path,
the method comprising:
setting, by the valve, the flow-through sequence on a basis of a current or future thermal capacity of a respective component.

16. The method according to claim 11, comprising:
obtaining a connection to the return by at least one bypass between the control unit and the electric machine.

17. The method according to claim 16, comprising:
setting, by a bypass valve, a flow volume through the bypass through the bypass valve.

18. The method according to claim 16, comprising:
altering, by the valve, the temperature control path such that the temperature control medium flows through the at least two components in parallel.

19. The method according to claim 16, comprising:
reducing, by a temperature control device, an overall pressure drop.
